(19) United States
(12) Patent Application Publication
(10) Pub. No.: US 2015/0088574 A1
(43) Pub. Date: Mar. 26, 2015

(54) REMINDERS AND ACTION ITEMS FOR PERSONAL INTERACTIONS

(71) Applicant: Evernote Corporation, Redwood City, CA (US)

(72) Inventors: Phil LIBIN, San Jose, CA (US); Max LEVCHIN, San Francisco, CA (US)

(21) Appl. No.: 14/470,115

(22) Filed: Aug. 27, 2014

Related U.S. Application Data
(60) Provisional application No. 61/880,381, filed on Sep. 20, 2013.

(51) Int. Cl. G06Q 10/10; H04W 68/00; H04W 64/00; H04L 29/06

(52) U.S. Cl. CPC G06Q 10/1095; H04L 67/42; H04W 68/00; H04W 64/00
USPC 705/7.19

(57) ABSTRACT

Automatically generating people reminders for a user of a mobile device includes obtaining information for each of the people reminders, the information indicating a specific event with at least one other person, detecting proximity of the at least one other person, and, in response to the other person being proximal to the user, providing the user with a notification. In response to the at least one other person being proximal to the user, the user may also be provided with an action item. The action item may be transferring a thing, providing a financial transaction, discussing certain subjects, and/or sharing a document. The reminder may be provided independent of any date and time. The at least one other condition includes proximity to a specific location and/or a particular time of day. The at least one other individual may be a member of a target group of individuals.

### CROSS-REFERENCE TO RELATED APPLICATIONS

This application claims priority to U.S. Prov. App. No. 61/880,381, filed Sep. 20, 2013, and entitled “SETTING REMINDERS AND ACTION ITEMS FOR PERSONAL INTERACTIONS”, which is incorporated herein by reference.

### TECHNICAL FIELD

This application is directed to the field of digital communications, especially in conjunction with social networks and location aware devices to identify network members in proximity of a member.

### BACKGROUND OF THE INVENTION

Notifications and reminders have long become mainstream features of mobile, desktop and cloud based software and services. For many users, notifications are analogous to news headlines, announcing new and periodic events and activities previously unknown to a recipient; combined with reminders, notifications may serve as wake-up calls for upcoming events and activities pre-scheduled by a user. Reminders are used in contemporary workflows as ubiquitous planning features associated with calendars and other scheduled and non-scheduled, one-time and re-occurring events.

Sources of events reflected in notifications and reminders may be internal and external. Examples of internal events and accompanying notifications include events generated by installed native applications running on a mobile device, schedule reminders for meetings and other calendar events scheduled by a user, projects and tasks performed by the user, etc. External events may include all kinds of incoming communications, events occurring in social networks such as posts by user's friends or other monitored members, electronic commerce, upcoming payments, travel or entertainment related events, and in general any type of online services and activities to which the user is subscribed or which the user may track otherwise.

Mobile and desktop operating systems, online software platforms, and services are increasingly offering notification mechanisms to third party developers, allowing them to alert users about updates of application status and content. In addition to developer support, portions of such notification systems may directly assist end users in customizing notification and reminders, including the scope and parameters for notifications and reminders. Several examples of notification and reminder control systems include:
OS X Mountain Lion Notification Center, which provides a customizable and unified view of pop-ups generated by third-party apps, Mail, Calendar, and other pre-loaded applications, as well as by Mac App Store updates. Notifications are available in several different design styles (customizable by users), such as badges, alerts, and banners, with or without sound accompaniment.
Android notification mechanism for third party applications where notifications may appear in a dedicated notification area on a mobile device's screen or in a dedicated notification drawer. Analogously to the previous OS X example, notifications may have different views and distinctive design elements, such as notification icons, title, body, additional info (such as notification count), etc. Of particular importance is an actionable nature of Android notifications: each notification must have at least one associated action. Repetitive notifications (such as, for example, arriving new emails) can be stacked and increase notification count.
Facebook's extensive notification system allows a user to set up notifications about various types of friends' activities, such as posts, events, likes, shares, in addition to new friend requests. All such notifications are individually customizable and may be delivered in a web browser, in a native application or via email.

Other notable examples of notification systems are Amazon Simple Notification service (SNS), reminders and notifications in calendar systems, such as Google Calendar or Microsoft Outlook, in the Blackboard educational software, etc.

With the advent of mobile location aware devices and software capabilities, multiple Location Based Services (LBS) have been developed that utilize notification for mobile applications such as local informational services, proximity marketing, asset recovery, mobile dating, etc.

Notwithstanding advances in the development of desktop, mobile and online notification and reminder systems, certain basic needs of users remain unanswered. Most notification systems reflect virtual, computer generated events, rather than physical events occurring to users and to groups of users. Additionally, a proliferation of location based services has been limited by privacy and security concerns.

Accordingly, it is desirable to develop advanced notification systems for secure location aware services employing physical presence and proximity of users and addressing privacy concerns.

### SUMMARY OF THE INVENTION

According to the system described herein, automatically generating people reminders for a user of a mobile device includes obtaining information for each of the people reminders, the information indicating a specific event with at least one other person, detecting proximity of the at least one other person, and, in response to the at least one other person being proximal to the user, providing the user with a notification. In response to the at least one other person being proximal to the user, the user may also be provided with an action item. The action item may be transferring a thing, providing a financial transaction, discussing certain subjects, and/or sharing a document. The information for each of the people reminders may include a specific time and date and the reminder may be provided to the user in response to the at least one other person being proximal to the user at a time close to the specific date and time. The reminder may be provided independent of any date and time. The information for each of the people reminders may include at least one other condition and the reminder may be provided to the user in response to the at least one other person being proximal to the user and the at least one other condition being met. The at least one other condition includes proximity to a specific location and/or a particular time of day. The at least one other condition may be provided by at least one electronic calendar entry of the user. The at least one other individual may be a member of a target group of individuals. Members of the target group of individuals may or may not be discoverable to all other members of the target group of individuals. The information for each of the people reminders may include a specific time and date for the specific event and the reminder may be provided to the user in response to at least a subset of members of the target group being proximal to the user at a time close to the specific date and time. The user and the at least one other individual may be members of a service and membership in the service may be provided by subscription, assignment, individual registration, and/or group registration. Proximity of the at least one other individual may be determined using GPS, Bluetooth, WiFi, GSM localization, SS7, and/or an Internet connection. The mobile device may include software that is pre-loaded with the device, installed from an app store, installed from a desktop computer, installed from media, and/or downloaded from a Web site. The mobile device may use an operating system selected from the group consisting of: iOS, Android OS, Windows Phone OS, Blackberry OS and mobile versions of Linux OS. The items may be stored using Outlook® calendaring software provided by the Microsoft Corporation of Redmond, Wash., the Apple iCal® calendaring software, or the Google Calendar™ calendaring application.

According further to the system described herein, computer software, provided in a non-transitory computer readable medium, automatically generates people reminders for a user of a mobile device. The software includes executable code that obtains information for each of the people reminders, the information indicating a specific event with at least one other person, executable code that detects proximity of the at least one other person, and executable code that provides the user with a notification in response to the at least one other person being proximal to the user. In response to the at least one other person being proximal to the user, the user may also be provided with an action item. The action item may be transferring a thing, providing a financial transaction, discussing certain subjects, and/or sharing a document. The information for each of the people reminders may include a specific time and date and the reminder may be provided to the user in response to the at least one other person being proximal to the user at a time close to the specific date and time. The reminder may be provided independent of any date and time. The information for each of the people reminders may include at least one other condition and the reminder may be provided to the user in response to the at least one other person being proximal to the user and the at least one other condition being met. The at least one other condition includes proximity to a specific location and/or a particular time of day. The at least one other condition may be provided by at least one electronic calendar entry of the user. The at least one other individual may be a member of a target group of individuals. Members of the target group of individuals may or may not be discoverable to all other members of the target group of individuals. The information for each of the people reminders may include a specific time and date for the specific event and the reminder may be provided to the user in response to at least a subset of members of the target group being proximal to the user at a time close to the specific date and time. The user and the at least one other individual may be members of a service and membership in the service may be provided by subscription, assignment, individual registration, and/or group registration. Proximity of the at least one other individual may be determined using GPS, Bluetooth, WiFi, GSM localization, SS7, and/or an Internet connection. The mobile device may include software that is pre-loaded with the device, installed from an app store, installed from a desktop computer, installed from media, and/or downloaded from a Web site. The mobile device may use an operating system selected from the group consisting of: iOS, Android OS, Windows Phone OS, Blackberry OS and mobile versions of Linux OS. The items may be stored using Outlook® calendaring software provided by the Microsoft Corporation of Redmond, Wash., the Apple iCal® calendaring software, or the Google Calendar™ calendaring application.

The proposed system automatically generates people reminders with alerts and associated action items that appear on a mobile device of a user every time the user comes into proximity of a designated individual or a group of individuals, possibly under certain additional temporal, spatial or other conditions.

People reminders may have numerous work, home and leisure applications; examples may include:
(a) “When I meet Tom and Sandy, show them on my iPhone new photos of our trip”.
(b) “Write Rob a $50 check the next time we meet.”
(c) “Talk to Mary about new project ideas when we meet today”.
(d) “Return a book I borrowed from John the next time he visits my home”.
(e) “If Laurie, Joe and Stacy will all participate in our 11 am editorial meeting, talk to them about a new revision of our upcoming article.”
(f) “If Ted and Jamie will be in Davies Hall tomorrow, show them a new release of Mahler's symphonies in the CD store”

As demonstrated by examples (a)-(f), people reminders may include a broad range of action items performed by a user when the user meets and communicates with a person or a group of people: transferring a thing, writing a check, talking about certain subject, showing a document or other content, etc. Such actions may be unconditional, depending only on meeting a target individual or a group, as in examples (a) and (b). Alternatively, actions may be conditional and may depend on a meeting time (such as today in the example (c)), place (my home in the example (d)), combinations of the above (examples (e) and (f)) or other circumstances, for example, a calendar of the user in the example (e). It is presumed that a target group of one or more individuals associated with a people reminder may be identified once people in the target group appear in the proximity of a user who has set up the people reminder and is tracking the group on a mobile device.

People reminders may reflect various scenarios of user communications that may spread between two extremes:
Repetitive well-defined interactions driven by schedules, routines and workflows, such as specific tasks within a meeting agenda that need to be discussed with particular co-workers or teams.
Ad hoc, non-mandatory and non-urgent interactions, activities and tasks that may be associated, from a user standpoint, with a certain person or a group of people. These activities are not necessarily driven by tight schedules and everyday routines and therefore may be easily overlooked in users' busy lives. However, a simple reminder, a note that a person or a group is nearby, may instantly bring up the purpose of the reminder and an associated action item that may be immediately fulfilled.

A useful feature of the proposed system is its ability to identify individuals and groups as the individuals and groups appear in a proximity to a user. Such identification has three components: membership, discoverable clusters, and situational discoverability, as explained below.

People reminders may be treated as a special type of LBS (Location Based Service) and may be available to members of the service by subscription, assignment, or other ownership methods that may presume individual or group registration. Each user of the system may be able to discover certain other members who form a discoverable cluster of the user. Methods of forming discoverable clusters may vary depending on the system design:
Members may know each other and may belong to one or more mutual lifestyle circles, such as co-workers, friends, members of a club or a volunteer organization, etc.
An organization may mandate subscription of its members to people reminder service(s) with the goal to improve organizational efficiency. Individual members may adopt a subscriber agreement issued on behalf of the organization, stating the rights and obligations of the members and protecting the privacy of the members.
Users may build discoverable clusters by invitations, similarly to lists of friends in social networks.
Various combinations of the above approaches may be used.

A discoverable cluster may be symmetric, so that each discoverable member may reciprocally discover the user who has originated the cluster; alternatively, a cluster may be asymmetric, where some or all discoverable members may not be able to discover an originating user under any circumstances. There may be different reasons for asymmetry of discoverable clusters, including organizational hierarchy, project specifics, etc.

Each people reminder created by a user designates a subset of individuals in discoverable cluster of a user and may define a notification and possibly an action when all designated individuals appear in a proximity to the user, provided that additional conditions, if any, are satisfied. The service may use diverse locating methods, such as GPS, Bluetooth, Wi-Fi, GSM localization, SS7 and any combination(s) of locating methods to enhance discoverability of service subscribers within a cluster. In some scenarios, identification of members of a target group associated with a people reminder may require an Internet connection; in other cases, identification of members may be done using peer-to-peer connections between devices and may be performed without an Internet connection by client side system software.

Irrespective of a set of positioning technologies used on mobile devices, cloud-based, client side or combined implementation of discovery events and other technical parameters, identification of a target group may be subject to additional conditions of situational discoverability, for example:
A meeting place may have technical obstacles (shielding, reception conditions, etc.) preventing one or more designated individuals from being discovered when the individuals appear in proximity of a system user.
Designated individuals may arrive without mobile devices used for discovery, may have the devices occasionally turned off or system software may not be running.
Some or all discoverable members may have a discovery option switched off for various reasons at the particular time of the discovery event.

Once a people reminder is displayed on a mobile device of a user, the user may decide, depending on circumstances, whether and how to communicate with the individual(s) who appeared in proximity of the user and how to fulfill any associated action. If the action has not been taken, the respective people reminder may remain active and may notify the user about subsequent discovery events.

In the event that a purpose of a reminder was fulfilled (for example, a book in the example (d), above, has been returned to its owner), a user may modify, disable or delete the reminder. If a reminder is non-recurrent, the system may mark the reminder as completed and subsequently delete the reminder. Managing recurrent, processed, expiring and other types of people reminders may be similar to calendar and other scheduler features.

From the user interface standpoint, the system may be implemented as a people reminder center that may be available across desktop, mobile and online platforms. System settings may allow a user to define multiple people reminders where each record may contain individuals or groups within a subscription cluster available to the user, additional conditions for displaying alerts, and associated action items. Real-time display of people reminders may follow notification design requirements of a mobile device; for example, people reminders may appear in drop-down notification areas on top of mobile screens or in notification drawers available on smartphones and tablets running Android and iOS mobile platforms.

### BRIEF DESCRIPTION OF THE DRAWINGS

Embodiments of the system described herein will now be explained in more detail in accordance with the figures of the drawings, which are briefly described as follows.

FIG. 1 is a schematic illustration of an unconditional people reminder with a single target individual and a GPS-based cloud-centric identification, according to an embodiment of to the system described herein.

FIG. 2 is a schematic illustration of an unconditional people reminder with a target group and a Wi-Fi-based identification, according to an embodiment of the system described herein.

FIG. 3 is a schematic illustration of a conditional people reminder with a target group, Bluetooth-based identification where a discovery event is conditioned by temporal and spatial requirements, according to an embodiment of the system described herein.

FIG. 4 is a schematic illustration of a people reminder center on a mobile device, according to an embodiment of the system described herein.

FIG. 5 is a system flow diagram describing functioning of the system, according to an embodiment of the system described herein.

### DETAILED DESCRIPTION OF VARIOUS EMBODIMENTS

The system described herein provides a mechanism for setting up and managing people reminders and a corresponding location based service, tracking target individuals and groups, notifying a user when the target group appears in user's proximity and other optional conditions are satisfied, and reminding the user about associated action items.

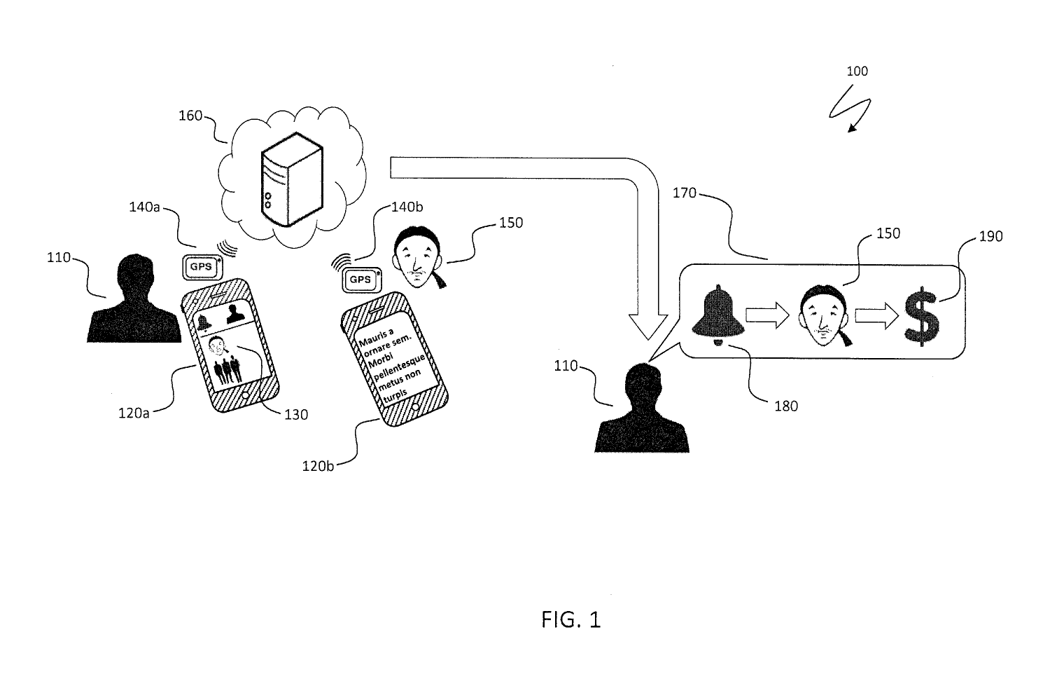

FIG. 1 is a schematic illustration 100 showing an unconditional people reminder with a single target individual and a GPS-based cloud-centric identification. A user 110 with a mobile device 120a running a people reminder application 130 utilizes a GPS technology 140a to communicate location of the user 110. A target individual 150 for an active people reminder has a mobile device 120b which is also using a GPS technology; both devices 120a, 120b communicate locations of the user and of the target individual to a cloud-based people reminder service 160. Once the service identifies a discovery event where the user 110 and the target individual 150 appear in a sufficient proximity, the service 160 generates and activates on the mobile device 120a of the user 110 a people reminder 170, which may include an alert 180, an indication of the target user 150 and an associated action 190.

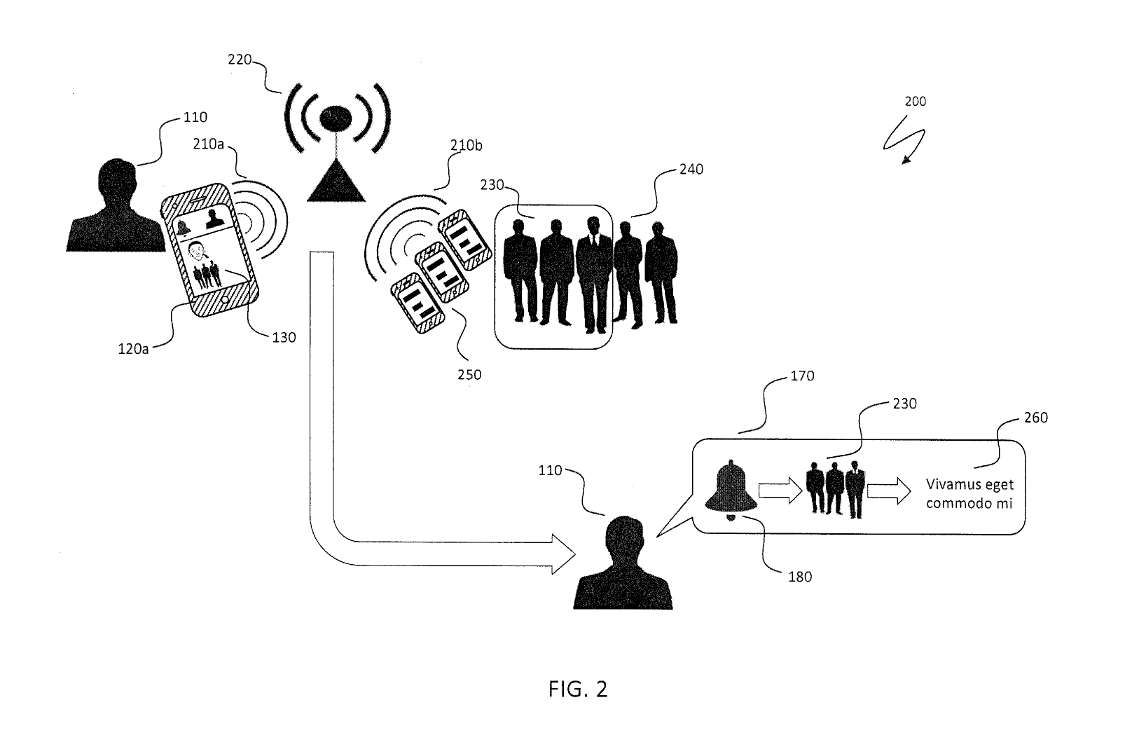

FIG. 2 is a schematic illustration 200 showing an unconditional people reminder with a target group and a Wi-Fi-based identification. Analogously to FIG. 1, the user 110 has the mobile device 120a running the people reminder application 130. Here, a Wi-Fi connection 210 to a wireless router 220 is employed by the user 110. A target group 230 may be part of a larger group 240 that comes close to the user 110; however, only members of the target group 230 are taken into account by the people reminder system; in the illustration 200, proximal people of the target group 230 are each using one or more of multiple mobile devices 250, which are also utilizing a Wi-Fi connection 210b. Once a discovery event occurs (explained elsewhere herein), the system generates for the user 110 the people reminder 170 with the alert 180, an indication of the target group 230 and an action item 260.

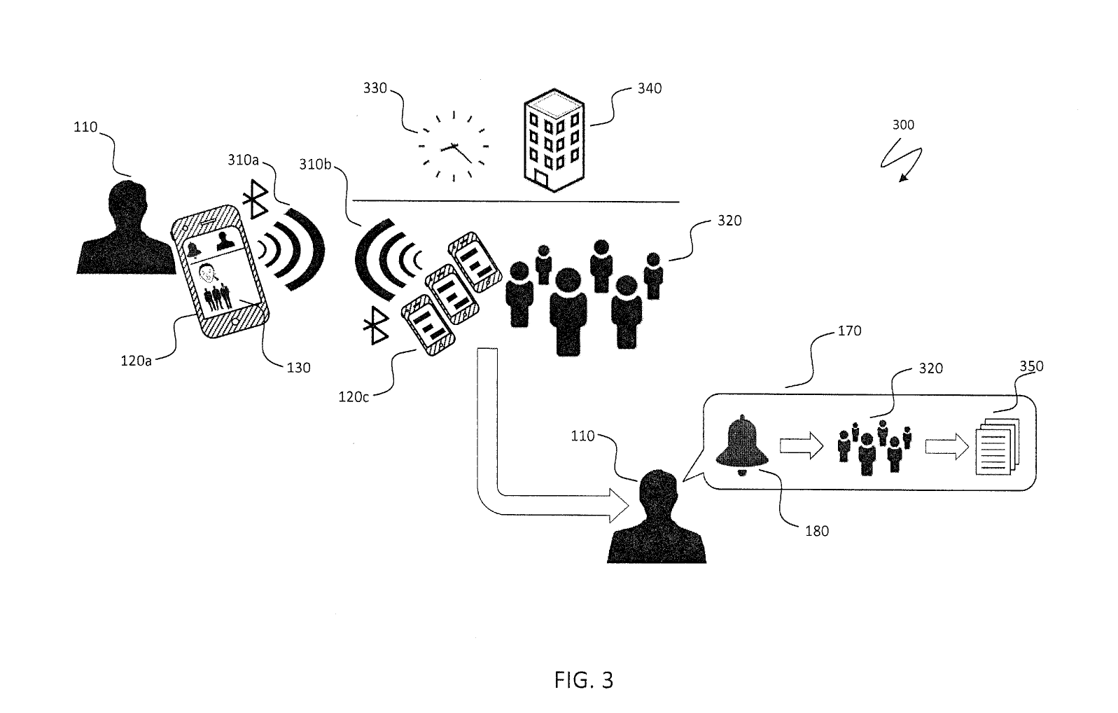

FIG. 3 is a schematic illustration 300 of a conditional people reminder with a target group, Bluetooth-based identification where a discovery event is conditioned by temporal and spatial requirements. Analogously to FIG. 1 and FIG. 2, the user 110 carries the mobile device 120a running the people reminder application 130 equipped with Bluetooth connectivity 310a. Members of a target group 320, each carry one or more of multiple mobile devices 120c that are also capable of Bluetooth connectivity 310b. Here, an assumption is made that devices 120c have been paired with the device 120a in the past; therefore, the people reminder application running on the user device 120a may discover members of the target group 320 when the members appear in the proximity of the user 110. However, discovering all members in the target group 320 does not trigger the people reminder application 130 in the illustration 300. There are two additional conditions, a temporal condition 330 (for example, “in the morning”) and a spatial condition 340 (for instance, “in our offices”) that must be satisfied in order for the system to generate a people reminder. In such case, the rest of the illustration is the same as in FIGS. 1, 2, with the people reminder 170 containing the alert 180, the target group 320 and an associated action 350.

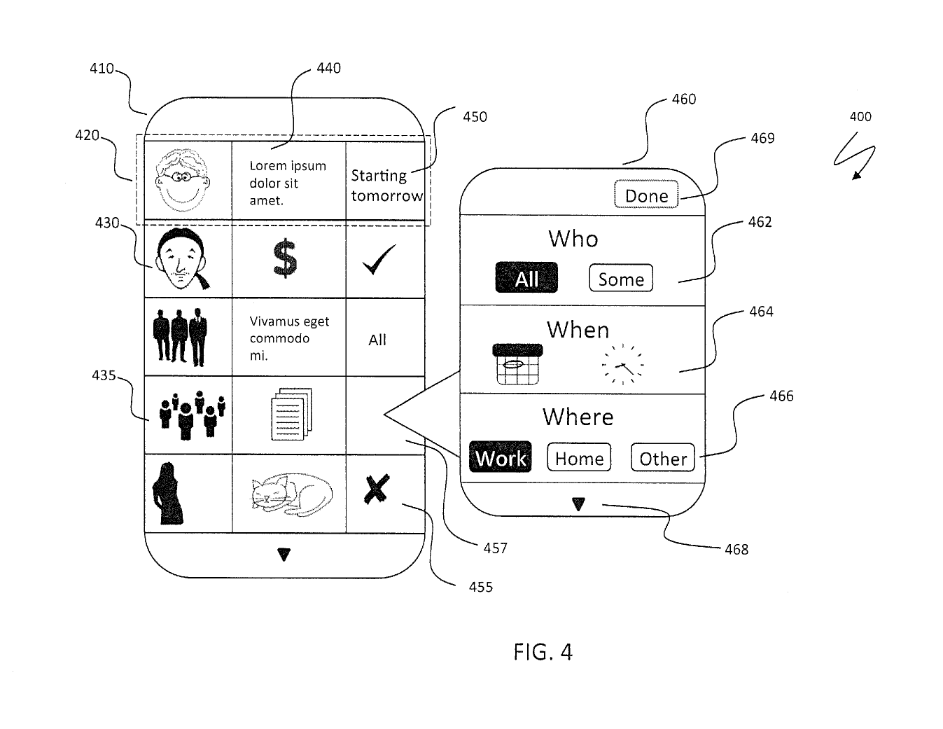

FIG. 4 is a schematic illustration of a people reminder center 400 on a mobile device. A main pane 410 of the people reminder center 400 is a collection of people reminders 420. Each people reminder may include a target group (which may be a single individual) 430, 435; an associated action 440; and a conditions field 450, which may also contain a people reminder status 455; in the example of FIG. 4, a mark corresponding to the status 455 illustrates a fulfilled and disabled people reminder record which may be purged from the list at a next reminder management session.

In order to modify values of people reminder fields, a reminder settings menu 460 may be used; in the people reminder center 400, the reminder settings menu 460 is applied, as an example, to a conditions field 457. The reminder settings menu 460 may include a people settings option 462, which may define, among other things, logic of detecting a discovery event. Thus, the people settings section 462 may establish a logical condition for activating a people reminder with the target group 435: the reminder may be activated when all (selected and currently used option) or some (available option) members of the target group appear in a proximity to the user. The reminder settings menu may also define temporal conditions for a discovery event, as illustrated in a section 464 of the settings. Such conditions may be tied to a scheduled item on a user calendar, as explained, in particular, in an example (e) above where a temporal condition is a meeting. Alternatively, temporal conditions may include an explicit time or time period setting, such as presented in examples (c) (today) and (f) (tomorrow) elsewhere herein. Analogously, spatial conditions may be defined by a location section 466 of option settings, which may include common locations, such as work and home, as well as other location types. Additional sections of the people reminder settings pane may help setting up various properties of the target group, actions, conditions and status of people reminders; these additional sections may be available by scrolling the settings pane, as schematically illustrated by a scrolling button 468.

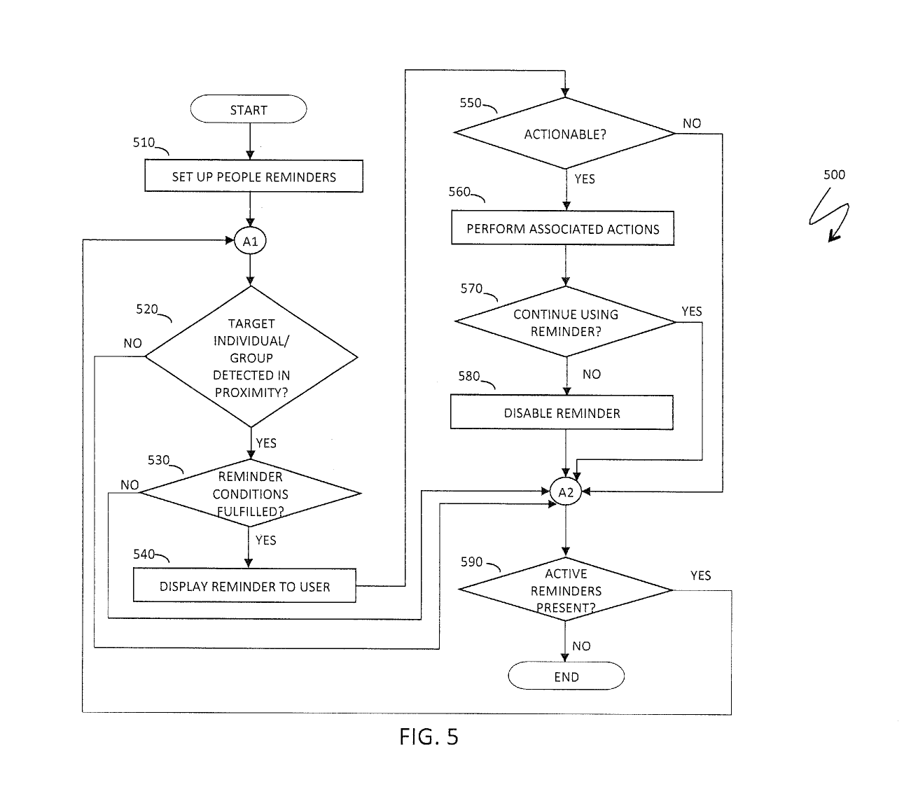

Referring to FIG. 5, a flow diagram 500 illustrates processing performed in connection with functioning of the system described herein. Processing begins at a step 510 where context user sets up people reminder(s) in a people reminder center, as explained elsewhere herein (see, for example, FIG. 4 and the accompanying text). After the step 510, processing proceeds to a test step 520 where it is determined by the system whether a target individual or group of individuals, defined in one or more of people reminders, has been detected in proximity of the user. If so, processing proceeds to a test step 530 where it is determined whether the corresponding people reminder conditions (if any) are fulfilled. If so, processing proceeds to a step 540 where the active reminder is displayed to the user, as explained elsewhere herein, see, for example, in FIGS. 1-3 and the corresponding text.

After the step 540, processing proceeds to a test step 550 where it is determined whether the displayed people reminder is actionable. If so, processing proceeds to a step 560 where the user performs actions associated with the displayed people reminder. After the step 560, processing proceeds to a test step 570 where it is determined whether it is desirable to continue using the fulfilled reminder (for example, whether the reminder is recurrent). If not, processing proceeds to a step 580 where the reminder is disabled. After the step 580, processing proceeds to a test step 590 where it is determined whether active (not disabled) reminders are still present in the people reminder center. Note that the step 590 may be independently reached from the test step 520 if the target individual or group are not detected in proximity of the user; from the test step 530 if the reminder conditions are not fulfilled; from the test step 550 if the displayed reminder does not have an associated action; and from the test step 570 if the user has decided to leave the reminder active. If it is determined at the test step 590 that active reminders are present, processing proceeds back to the step 520; otherwise, processing is complete.

Various embodiments discussed herein may be combined with each other in appropriate combinations in connection with the system described herein. Additionally, in some instances, the order of steps in the flowcharts, flow diagrams and/or described flow processing may be modified, where appropriate. Subsequently, elements and areas of screen described in screen layouts may vary from the illustrations presented herein. Further, various aspects of the system described herein may be implemented using software, hardware, a combination of software and hardware and/or other computer-implemented modules or devices having the described features and performing the described functions. The mobile device may be a cell phone or a tablet, although other devices, such as a laptop or desktop computer, are also possible. The mobile device may include software that is pre-loaded with the device, installed from an app store, installed from a desktop (after possibly being pre-loaded thereon), installed from media such as a CD, DVD, etc., and/or downloaded from a Web site. The mobile device may use an operating system selected from the group consisting of: iOS, Android OS, Windows Phone OS, Blackberry OS and mobile versions of Linux OS. The reminders and/or alerts may be stored and/or generated using the Outlook® calendaring software provided by the Microsoft Corporation of Redmond, Wash., the Apple iCal® calendaring software, and the Google Calendar™ calendaring application.

Software implementations of the system described herein may include executable code that is stored in a computer readable medium and executed by one or more processors. The computer readable medium may be non-transitory and include a computer hard drive, ROM, RAM, flash memory, portable computer storage media such as a CD-ROM, a DVD-ROM, a flash drive, an SD card and/or other drive with, for example, a universal serial bus (USB) interface, and/or any other appropriate tangible or non-transitory computer readable medium or computer memory on which executable code may be stored and executed by a processor. The system described herein may be used in connection with any appropriate operating system.

Other embodiments of the invention will be apparent to those skilled in the art from a consideration of the specification or practice of the invention disclosed herein. It is intended that the specification and examples be considered as exemplary only, with the true scope and spirit of the invention being indicated by the following claims.

What is claimed is:

1. A method of automatically generating people reminders for a user of a mobile device, comprising:
obtaining information for each of the people reminders, the information indicating a specific event with at least one other person;
detecting proximity of the at least one other person; and
in response to the at least one other person being proximal to the user, providing the user with a notification.

2. A method, according to claim 1, wherein, in response to the at least one other person being proximal to the user, the user is also provided with an action item.

3. A method, according to claim 2, wherein the action item is selected from the group consisting of: transferring a thing, providing a financial transaction, discussing certain subjects, and sharing a document.

4. A method, according to claim 1, wherein the information for each of the people reminders includes a specific time and date and the reminder is provided to the user in response to the at least one other person being proximal to the user at a time close to the specific date and time.

5. A method, according to claim 1, wherein the reminder is provided independent of any date and time.

6. A method, according to claim 1, wherein the information for each of the people reminders includes at least one other condition and the reminder is provided to the user in response to the at least one other person being proximal to the user and the at least one other condition being met.

7. A method, according to claim 6, wherein the at least one other condition includes at least one of: proximity to a specific location and a particular time of day.

8. A method, according to claim 6, wherein the at least one other condition is provided by at least one electronic calendar entry of the user.

9. A method, according to claim 1, wherein the at least one other individual is a member of a target group of individuals.

10. A method, according to claim 9, wherein members of the target group of individuals are discoverable to all other members of the target group of individuals.

11. A method, according to claim 9, wherein at least some members of the target group are not discoverable by other members of the target group.

12. A method, according to claim 9, wherein the information for each of the people reminders includes a specific time and date for the specific event and the reminder is provided to the user in response to at least a subset of members of the target group being proximal to the user at a time close to the specific date and time.

13. A method, according to claim 1, wherein the user and the at least one other individual are members of a service and wherein membership in the service is provided by at least one of: subscription, assignment, individual registration, and group registration.

14. A method, according to claim 1, wherein proximity of the at least one other individual is determined using at least one of: GPS, Bluetooth, WiFi, GSM localization, SS7, and an Internet connection.

15. A method, according to claim 1, wherein the mobile device includes software that is one of: pre-loaded with the device, installed from an app store, installed from a desktop computer, installed from media, and downloaded from a Web site.

16. A method, according to claim 1, wherein the mobile device uses an operating system selected from the group consisting of: iOS, Android OS, Windows Phone OS, Blackberry OS and mobile versions of Linux OS.

17. A method, according to claim 1, wherein the items are stored using one of: Outlook® calendaring software provided by the Microsoft Corporation of Redmond, Wash., the Apple iCal® calendaring software, and the Google Calendar™ calendaring application.

18. Computer software, provided in a non-transitory computer readable medium, that automatically generates people reminders for a user of a mobile device, the software comprising:
executable code that obtains information for each of the people reminders, the information indicating a specific event with at least one other person;
executable code that detects proximity of the at least one other person; and
executable code that provides the user with a notification in response to the at least one other person being proximal to the user.

19. Computer software, according to claim 18, wherein, in response to the at least one other person being proximal to the user, the user is also provided with an action item.

20. Computer software, according to claim 19, wherein the action item is selected from the group consisting of: transferring a thing, providing a financial transaction, discussing certain subjects, and sharing a document.

21. Computer software, according to claim 18, wherein the information for each of the people reminders includes a specific time and date and the reminder is provided to the user in response to the at least one other person being proximal to the user at a time close to the specific date and time.

22. Computer software, according to claim 18, wherein the reminder is provided independent of any date and time.

23. Computer software, according to claim 18, wherein the information for each of the people reminders includes at least one other condition and the reminder is provided to the user in response to the at least one other person being proximal to the user and the at least one other condition being met.

24. Computer software, according to claim 23, wherein the at least one other condition includes at least one of: proximity to a specific location and a particular time of day.

25. Computer software, according to claim 23, wherein the at least one other condition is provided by at least one electronic calendar entry of the user.

26. Computer software, according to claim 18, wherein the at least one other individual is a member of a target group of individuals.

27. Computer software, according to claim 26, wherein members of the target group of individuals may discover all other members of the target group of individuals.

28. Computer software, according to claim 26, wherein at least some members of the target group are not discoverable by other members of the target group.

29. Computer software, according to claim 26, wherein the information for each of the people reminders includes a specific time and date for the specific event and the reminder is provided to the user in response to at least a subset of members of the target group being proximal to the user at a time close to the specific date and time.

30. Computer software, according to claim 18, wherein the user and the at least one other individual are members of a service and wherein membership in the service is provided by at least one of: subscription, assignment, individual registration, and group registration.

31. Computer software, according to claim 18, wherein proximity of the at least one other individual is determined using at least one of: GPS, Bluetooth, WiFi, GSM localization, SS7, and an Internet connection.

32. Computer software, according to claim 18, wherein the mobile device includes software that is one of: pre-loaded with the device, installed from an app store, installed from a desktop computer, installed from media, and downloaded from a Web site.

33. Computer software, according to claim 18, wherein the mobile device uses an operating system selected from the group consisting of: iOS, Android OS, Windows Phone OS, Blackberry OS and mobile versions of Linux OS.

34. Computer software, according to claim 18, wherein the items are stored using one of: Outlook® calendaring software provided by the Microsoft Corporation of Redmond, Wash., the Apple iCal® calendaring software, and the Google Calendar™ calendaring application.
